(19) United States
(12) Patent Application Publication
(10) Pub. No.: US 2008/0066008 A1
(43) Pub. Date: Mar. 13, 2008

(54) Visual Control Interface for Controlling Multi-Window Display System

(76) Inventor: Jen-Her Jeng, Linnei Township (TW)

Correspondence Address: LAW OFFICES OF LAI AND ASSOCIATES, P.C., 5800 RANCHESTER STE 200, HOUSTON, TX, 77036, US

(21) Appl. No.: 11/531,653

(22) Filed: Sep. 13, 2006

(51) Int. Cl. G06F 9/00; G06F 3/00

(52) U.S. Cl. 715/802; 715/810; 715/835; 715/804

(57) ABSTRACT

A visual interface for controlling a multi-window display system is disclosed. The visual interface includes at least one session icon, a multiple of window icons and at least one link icon. When the session icon receives a selection signal, the operation focus of the multi-window display system is transferred to the selected session. The window icons are corresponding to the windows of the session with operation focus. When one of the window icons receives the selection signal, the multi-window display system will control the display of the selected window. When the link icon receives the selection signal, the multi-window display system transfers the operation focus to the session with predetermined link objectives or the window with link objectives.

### FIELD OF THE INVENTION

The present invention relates to a visual control interface for controlling a multi-window display system, and more particularly to a control interface having a link function.

### BACKGROUND OF THE INVENTION

At present, computers have become indispensable to our life, and the Windows operating system provides a visual operating interface to enhance the convenience of operating a computer. As computer applications become popular, various Windows application programs such as Word program for word processing, Excel program for designing spreadsheets, PowerPoint program for conducting presentations and MultiMedia Player for playing audio/video files are introduced. These Window application programs play very important roles for a salesperson's presentation, a teacher's slides for lectures or speeches, and a presenter's data, forms and illustrations. As the presentation of data becomes increasingly complicated, a user may use more than one application program at a time. For instance, a professor may use PowerPoint for illustrations while using Excel to show tables and data for assisting the illustrations or play a documentary film to impress audiences in a speech. Although the Windows operating system can display the windows of several application programs simultaneously, the speaker has to control the position, size and operation focus of several windows, and thus it will affect the speaker's concentration on presenting the content of the speech and lower the quality of the speech. Therefore, several window editing systems and presentation systems are used for displaying several files of different formats simultaneously as the volume of data increases. Further, a large quantity of data can be divided by sessions, and different sessions can be linked by a link function, and the mode of such data management is very similar to the learning process by human brains, and thus the invention can improve the efficiency of managing user's knowledge database.

However, the operating interface of a traditional multi-window presentation system requires users to remember a large number of instructions or the users must carry out many steps before achieving the effect, and such arrangement will lower the efficiency of the multi-window presentation system. Therefore, a more user-friendly and instinctive multi-window operating interface is urgently needed.

In view of the shortcomings of the prior art, the inventor of the present invention based on years of experience in the area of Windows application programs to provide a multi-window file editing system and its method and multi-window file presentation system and its method to overcome the foregoing shortcomings.

The inventor of the present invention also provides a visual control interface for controlling a multi-window display system and its method to overcome the foregoing shortcomings.

### SUMMARY OF THE INVENTION

In view of the description above, the primary objective of the present invention is to provide a visual control interface for controlling a multi-window display system, which is a more user-friendly and instinctive operating interface for achieving the effect of enhancing the operating efficiency of the multi-window display system.

To achieve the foregoing objective, the present invention provides a visual control interface for controlling a multi-window display system, and the multi-window display system includes at least one session, and the session includes a plurality of windows, and the visual control interface includes at least one session icon, a plurality of window icons and at least one link icon. The session icon corresponds to a respective session of the multi-window display system, such that when the session icon receives a selection signal, the multi-window display system converts the operation focus into the selected session. These window icons correspond to the windows of the respective sessions having the operation focus, such that when one of the window icons receives the selection signal, the multi-window display system will display a control of the selected window. When the link icon receives the selection signal, the multi-window display system converts the operation focus into a session with predetermined link objectives or a window with predetermined link objectives

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a schematic diagram of a visual control interface according to a preferred embodiment of the present invention;

FIG. 2 is a schematic diagram of a visual control interface according to a preferred embodiment of the present invention; and

FIG. 3 is a schematic diagram of a visual control interface according to a preferred embodiment of the present invention.

### DETAILED DESCRIPTION OF THE PREFERRED EMBODIMENTS

In the related figures for a preferred embodiment of a visual control interface for controlling a multi-window display system in accordance with the present invention, the same numeral is used for labeling the same element in the embodiment to make it easier for our examiner to understand the present invention.

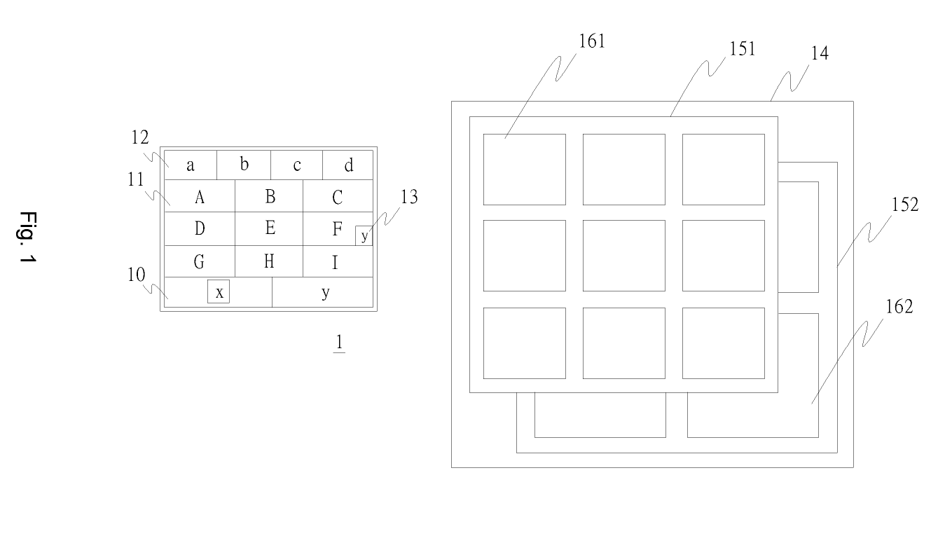

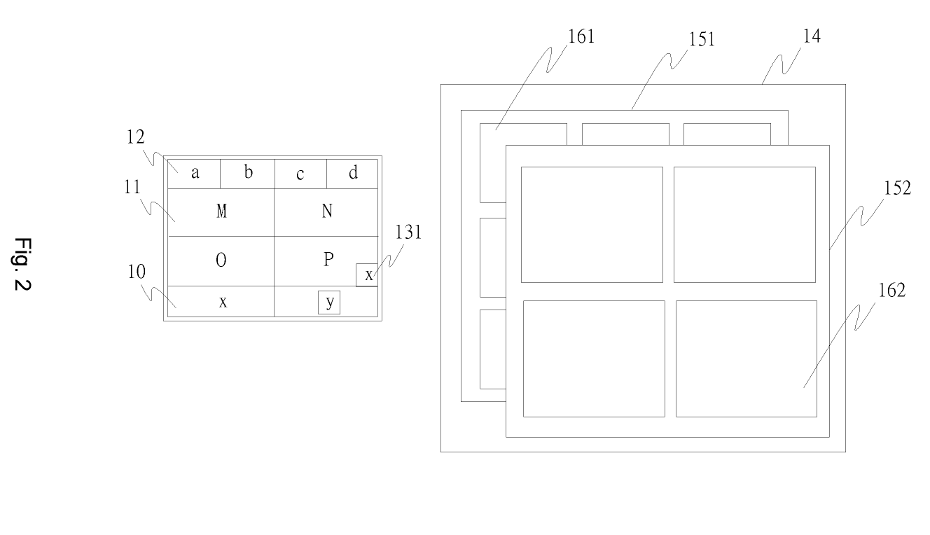

Referring to FIGS. 1 and 2 for the schematic views of a visual control interface of the present invention, the visual control interface 1 as shown in FIG. 1 comprises a plurality of session icons 10, a plurality of window icons 11, a plurality of function icons 12 and a plurality of link icons 13. The visual control interface 1 is provided for controlling a multi-window display system 14. The plurality of session icons 10 are represented by x and y in FIG. 1 corresponding to a session 151 and a session 152 of the multi-window display system 14 respectively When the session icon 10 receives a selection signal (for example, a user moves the cursor to one of the session icons 10 and presses a button), the multi-window display system 14 converts the operation focus into the selected session. In FIG. 1, x has a frame line, and y does not have the frame line, indicating that the current operation focus is at the session 151. If a user moves the cursor to y and presses the left button of a mouse, y will receives a selection signal, and the multi-window display system 14 will convert the operation focus into the session 152 as shown in FIG. 1. The session 152 is the session currently operated by the user and covered onto the session 151, wherein the number of session icons 10 corresponds to the number of sessions in the multi-window display system 14.

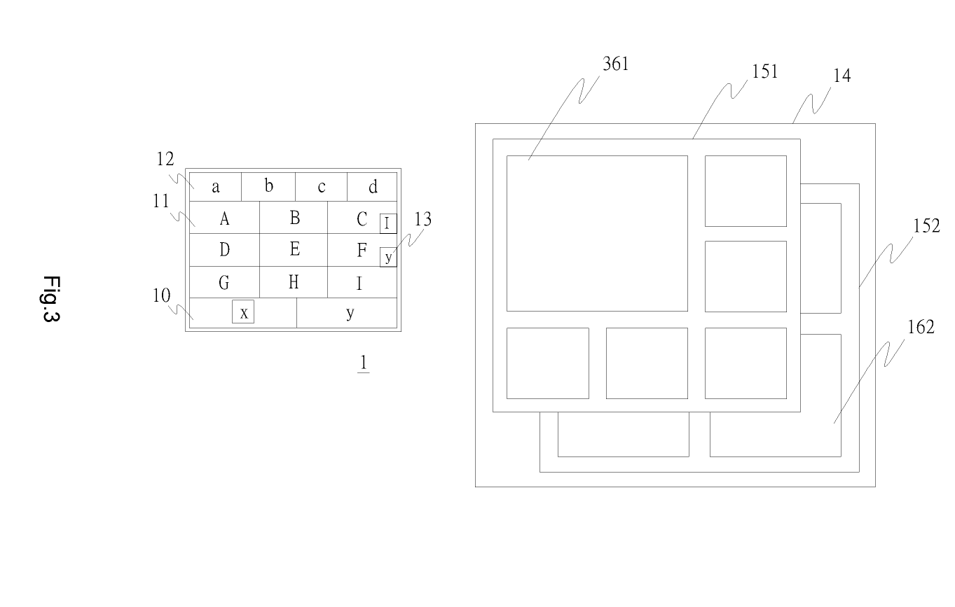

The window icons 11 correspond to the windows of respective sessions having the operation focus as indicated by A˜I in FIG. 1 and indicated by M˜P in FIG. 2. If the multi-window display system 14 converts the operation focus, the visual control interface 1 will update the window icons 11. If one of the window icons 11 receives the selection signal, then the multi-window display system 14 will control a display of the selected window. For example, if a user moves the cursor to A and presses the press button, then the multi-window display system 14 will change the window screen of the session 151 at the upper left corner of the window according to a predetermined position and size as shown in FIG. 3. The window 361 is an enlarged window of the window at the upper right corner of FIG. 1.

If the link icon 13 receives the selection signal, then the multi-window display system 14 will convert the operation focus into a session with predetermined link objectives or a window with predetermined link objectives. In FIG. 1, if a user moves the cursor onto the link icon 13 and presses the press button, then the multi-window display system 14 will convert the operation focus into the session 152. In FIG. 2, if the user moves the cursor onto the link icon 131 and presses the press button, then the multi-window display system 14 will convert the operation focus into the session 151. The link icon 13 can remind users by blinking that such session has a linked window or a linked session.

In FIG. 1, a plurality of function icons 10 are represented by and which correspond to opening a file, recovering a normal screen, jumping to next session and returning to previous session. If a user moves the cursor onto c and presses the press button, the multi-window display system 14 will execute the function of jumping to next session and will convert the operation focus into the next session. If a user moves the cursor onto b and presses the press button, the multi-window display system 14 will recover the screen back to the original multi-window screen.

In FIGS. 1 to 3, the visual control interface 1 and the multi-window display system 14 are displayed at different positions of the screen for the simplicity of the illustration, but in actual practices, the visual control interface 1 and the multi-window display system 14 can be displayed on the same screen and displayed one on top of the other. In general, the visual control interface 1 can be hidden, so that when a user needs the visual control interface 1, the user can move the cursor to the top of the screen to show the visual control interface 1 and allow users to operate the visual control interface 1.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A visual control interface for controlling a multi-window display system, and said multi-window display system having at least one session, and said session having a plurality of windows, and said visual control interface comprising:
at least one session icon, corresponding to said session of said multi-window display system, such that if said session icon receives a selection signal, then said multi-window display system will convert an operation focus to said selected session;
a plurality of window icons, corresponding to a window of a session having said operation focus, such that if one of said window icons receives said selection signal, then said multi-window display system will control a display of said selected window; and
at least one link icon, such that if said link icon receives said selection signal, then said multi-window display system will convert said operation focus into a session with predetermined link objectives or a window with predetermined link objectives.

2. The visual control interface of claim 1, further comprising at least one function icon, such that if said function icon receives said selection signal, then said multi-window display system will execute a corresponding function selected by said function icon.

3. The visual control interface of claim 1, wherein said corresponding function comprises a corresponding function of opening a file, recovering a normal screen, jumping to next session, or jumping to previous session.

4. The visual control interface of claim 1, wherein said window includes a matrix of N×M window icons, and N and M are integers greater than or equal to 1, and N×M is an integer greater than 1.

5. The visual control interface of claim 1, wherein said session or window having said operation focus is displayed in different colors.

6. The visual control interface of claim 1, wherein said link icon is displayed in different colors or in a blinking manner.

7. The visual control interface of claim 1, wherein said visual control interface is displayed in a semi-transparent manner.

8. The visual control interface of claim 1, wherein said visual control interface can be hidden.
